(19) United States
(12) Patent Application Publication
(10) Pub. No.: US 2011/0305175 A1
(43) Pub. Date: Dec. 15, 2011

(54) SELF-CONTAINED ANTENNA DEVICE WITH QUICK AIMING SWITCHING

(75) Inventors: Serge Hethuin, Courbevoie (FR); Arnaud Tonnerre, Asnieres-sur-Seine (FR); Pierre Gasowski, Issy les Moulineaux (FR)

(73) Assignee: THALES, Neuilly Sur Seine (FR)

(21) Appl. No.: 13/119,734

(22) PCT Filed: Sep. 21, 2009
(86) PCT No.: PCT/EP2009/062222

§ 371 Date: Aug. 18, 2011

(30) Foreign Application Priority Data
Sep. 19, 2008 (FR) 0805151

(51) Int. Cl. H01Q 3/12; H04W 88/02

(52) U.S. Cl. 370/310; 342/374

(57) ABSTRACT

The present invention includes an autonomous antennal device with fast pointing switching. The antennal device has an electron beam switching antenna, and the device is linkable by a cable to a radioelectric facility. The device includes a calculation unit to determine a direction of pointing of the beam of the antenna on the basis of measurement parameters for the radiofrequency signal processed by the facility, and the parameters are received on a communication interface of the device. The invention applies, for example, to intelligent antennas, sometimes designated by the acronym FESA, which stands for Fast Electronically Steerable Antenna.

The present invention relates to an autonomous antennal device with fast pointing switching. The invention applies more particularly to intelligent antennas, sometimes designated by the acronym FESA for “Fast Electronically Steerable Antenna”.

FESA antennas are called on to be used with numerous radiofrequency access technologies, such as for example WiMAX or WiFi. This is because these antennas exhibit advantageous characteristics. Notably, they may be provided with a high gain, greater than 15 dBi for example, and they can change the direction of their beam very rapidly, in azimuth for example, often in a few hundred nanoseconds. These characteristics make it possible, notably, to increase the coverage of the network, and to resist interference or a jammer, and culminate in better management of the spectrum. Furthermore, this type of antenna may be implemented for diverse cases of use and in systems relying on various network architectures with varied topologies such as, for example, point-to-point, point-to-multipoint, meshed networks (centralized or distributed) and tree networks.

The constraints applied to the antenna are not the same for each of these topologies. Moreover, the antenna's performance requirements depend on the type of network node to which the antenna is fitted. For example, in a point-to-multipoint network, the central point requires an antenna for which the time to switch between two beam directions is much smaller than for the antennas fitted to the subscriber stations.

Conventionally, an FESA antenna connected to a radioelectric facility, for example a modem, is controlled directly by the modem's real-time electronic circuits, these circuits being for example programmable logic circuits of FPGA type, the initials standing for “Field Programmable Gate Array”. These circuits determine a desired direction of antenna pointing and convey said direction to the antenna via a low-level access protocol, operating, according to a terminology specific to the field of networks, at the level of the second layer of the OSI (“Open Systems Interconnection”) model, this layer often being designated by the acronym MAC standing for “Media Access Control”. Moreover, a link, wired or wireless, links the modem to the FESA antenna and transports the pointing information which the antenna needs in order to orient its beam in the desired direction.

This architecture makes it necessary to access software modules belonging to the bottom layers of the architecture of the modem, and consequently requires modifications of said bottom layers. Such modifications within the modem are sometimes impossible since the circuits and the software embedded in the modem are not always accessible for the user desiring to control the antenna via said modem. Even when these modifications are possible, they are not always tolerated, since they risk introducing malfunctions within the modem. Finally, when these modifications are possible and carried out, they give rise to significant cost overheads, notably because of the requalification procedures to be performed a posteriori on the modified modem.

An aim of the invention is to render the FESA antenna as independent as possible of the radioelectric facility, stated otherwise, allow a radioelectric facility to control said antenna without having to modify the bottom layers of said facility. For this purpose, the subject of the invention is an antennal device comprising an electron beam switching antenna, said device being linkable by a cable to a radioelectric facility, said device being characterized in that it comprises a calculation unit able to determine and command a direction of pointing of the beam of the antenna on the basis of measurement parameters for the radiofrequency signal processed by said facility, said parameters being conveyed by said facility on a communication interface of said device.

The antennal device according to the invention presents notably the advantage of being able to be used with modems of different technologies such as WiMAX or WiFi. It can therefore be implemented with most wireless communication facilities on condition that the antenna is designed to operate in the same frequency band as the facility and that the latter uses a standardized communication interface. Advantageously, the antennal device is implemented so as to transmit and receive radiofrequency signals of 2 GHz or more. To use this antennal device in a particular band of frequencies it therefore suffices to adapt its antenna to said band.

According to one embodiment of the antennal device according to the invention, the measurement parameters for the radiofrequency signal comprise at least one value from among the following:
a power indicator for said signal;
an indicator of quality of the communication linkup effected via said signal, such as, for example, the binary error rate after demodulation of the signal.

According to one embodiment of the antennal device according to the invention, the radioelectric facility is provided with an Ethernet port, and the communication interface of the antennal device suitable for receiving the measurement parameters is an Ethernet port able to supply voltage to the calculation unit and the antenna, advantageously by virtue of the “Power over Ethernet” technology.

The antennal device according to the invention can comprise a supply voltage adaptor able to reduce the supply voltage to a voltage compatible with the operation of the calculation unit and the antenna, the voltage adaptor being placed between the Ethernet port and the calculation unit.

According to another embodiment, the radioelectric facility is provided with a serial port and the communication interface of the antennal device according to the invention, suitable for receiving the measurement parameters, is a serial port, the device comprising a specific access for the electrical power supply.

The radioelectric facility may be provided with a multiplexing interface and the communication interface of the antennal device according to the invention, suitable for receiving the measurement parameters, can receive and demultiplex an electrical supply current, messages arising from the radioelectric facility and the radiofrequency signal to be transmitted by the antenna, the multiplexing interface for the radioelectric facility being able to multiplex said messages and the radiofrequency signal to be transmitted by the antenna, said messages comprising said measurement parameters.

The radioelectric facility may be provided with a multiplexing interface and with a first short-range radio transmission/reception port and the communication interface of the antennal device according to the invention, suitable for receiving the measurement parameters, may be a second short-range radio transmission/reception port, the messages arising from the radioelectric facility being conveyed on a wireless link between the first radio transmission/reception port and the second radio/transmission port, said messages comprising said measurement parameters.

The messages conveyed between the radioelectric facility and the antennal device can comprise orders for controlling the calculation unit, which make it possible, for example, to synchronize the device with the radioelectric facility, to choose and/or trigger a procedure for determining the direction of pointing of the antenna or to acknowledge receipt of an order previously conveyed. In return, the antennal device, through its communication interface, can send back messages regarding requests or information to the radioelectric facility.

The subject of the invention is also an antennal system comprising a modem controlling an electron beam switching antenna, the antenna being included in an antennal device as claimed in one of the preceding claims.

The antennal device according to the invention can, for example, be used as client of WiFi type or client of WiMAX type. It may be employed in RF beamed roaming networks, notably networks installed temporarily for events (natural disasters or demonstrations, for example).

Other characteristics will become apparent on reading the detailed description given by way of nonlimiting example which follows offered in relation to appended drawings which represent:

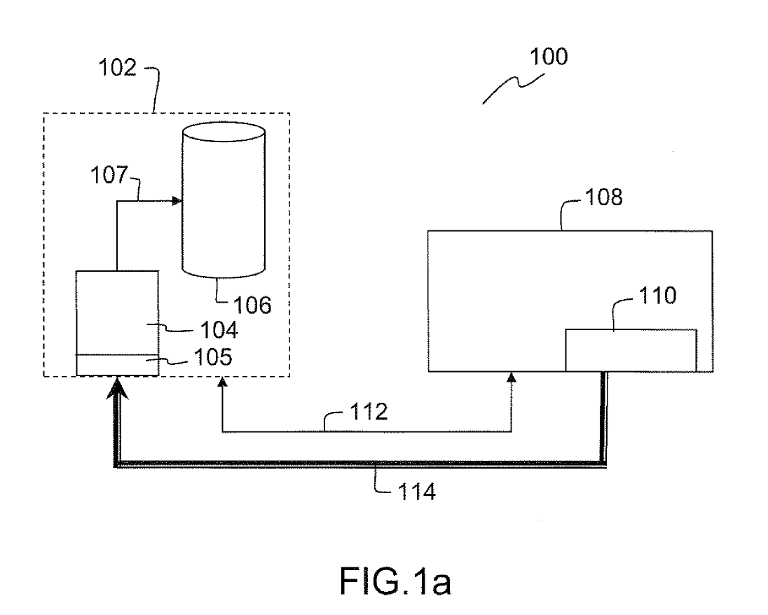

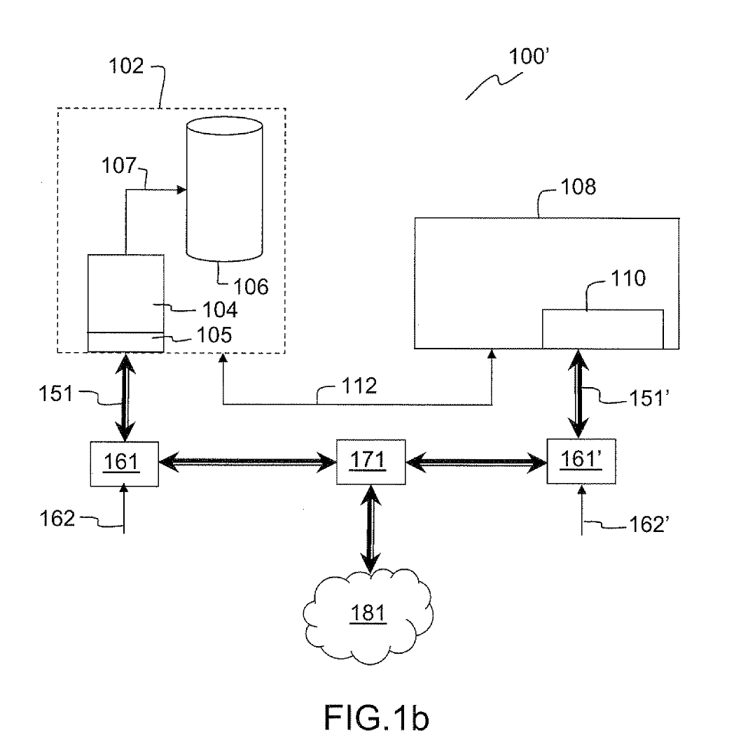

FIG. 1a, the architecture of a first system comprising an antennal device according to the invention,

FIG. 1b, the architecture of a second system comprising an antennal device according to the invention,

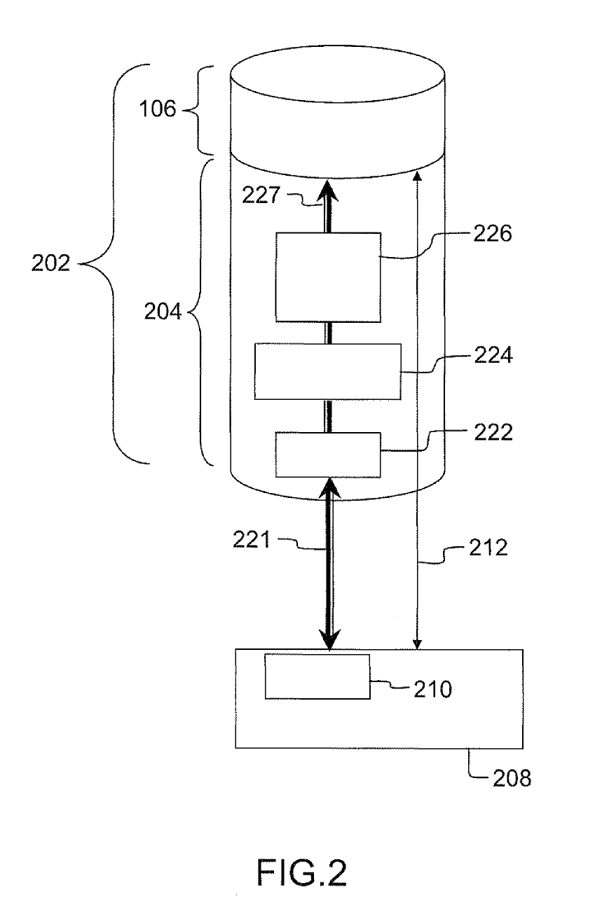

FIG. 2, the architecture of a first embodiment of the antennal device according to the invention,

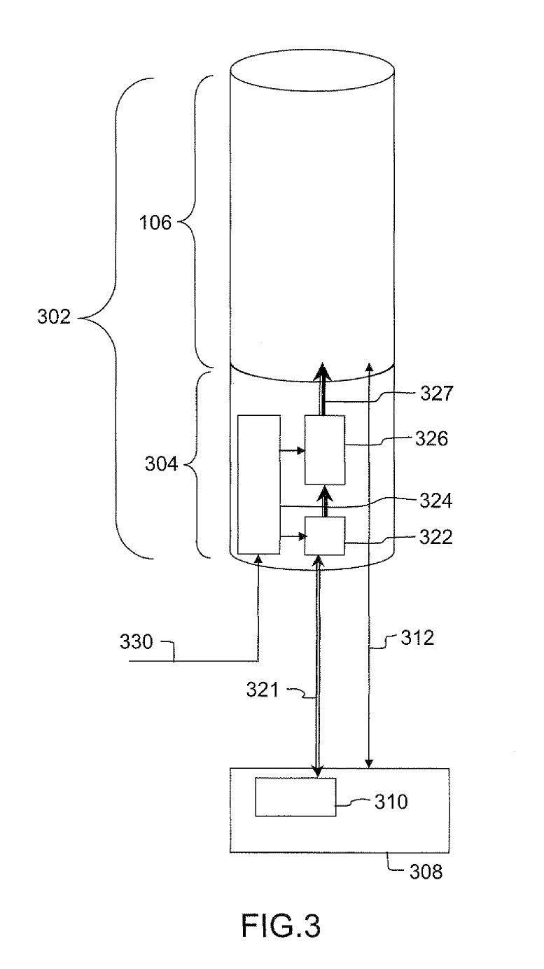

FIG. 3, the architecture of a second embodiment of the antennal device according to the invention,

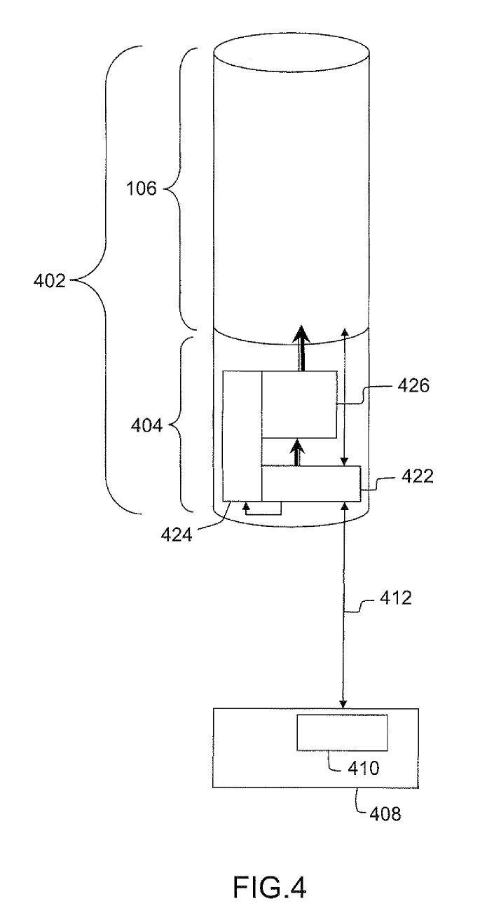

FIG. 4, the architecture of a third embodiment of the antennal device according to the invention,

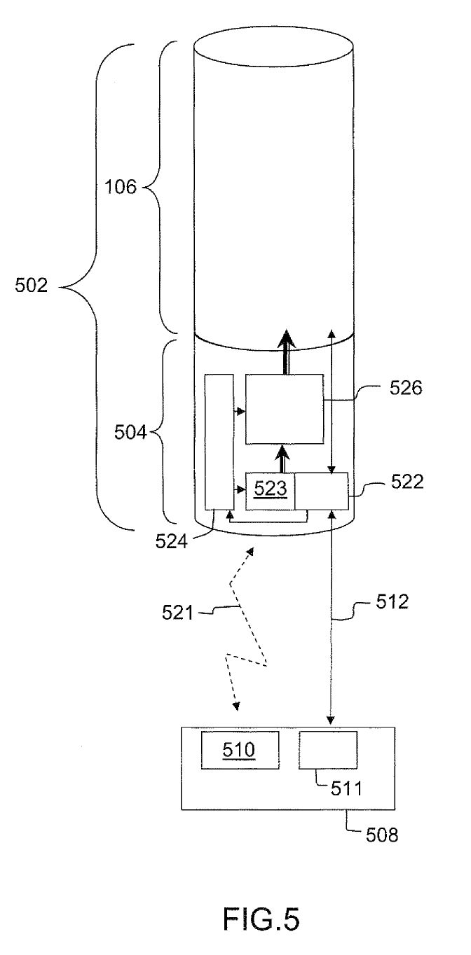

FIG. 5, the architecture of a fourth embodiment of the antennal device according to the invention,

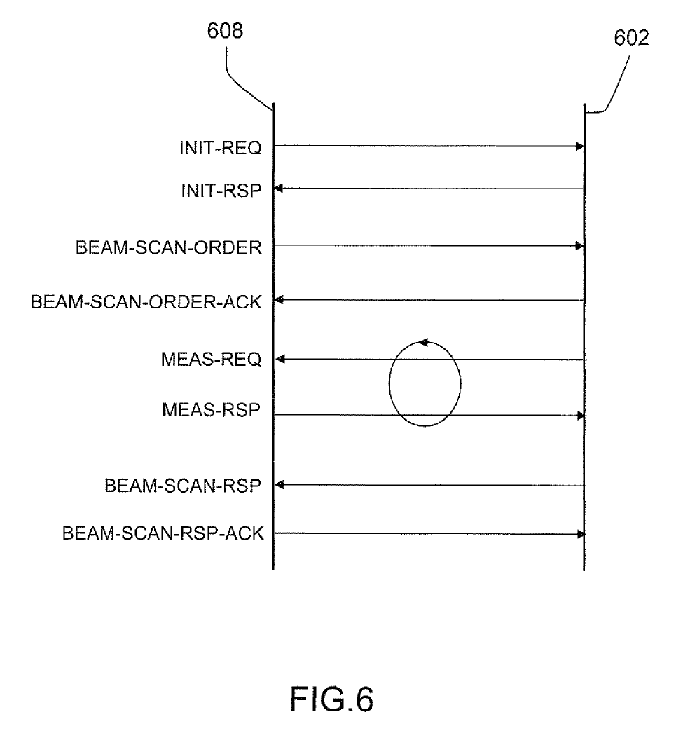

FIG. 6, an exemplary protocol for exchange between a radioelectric facility and an antennal device according to the invention,

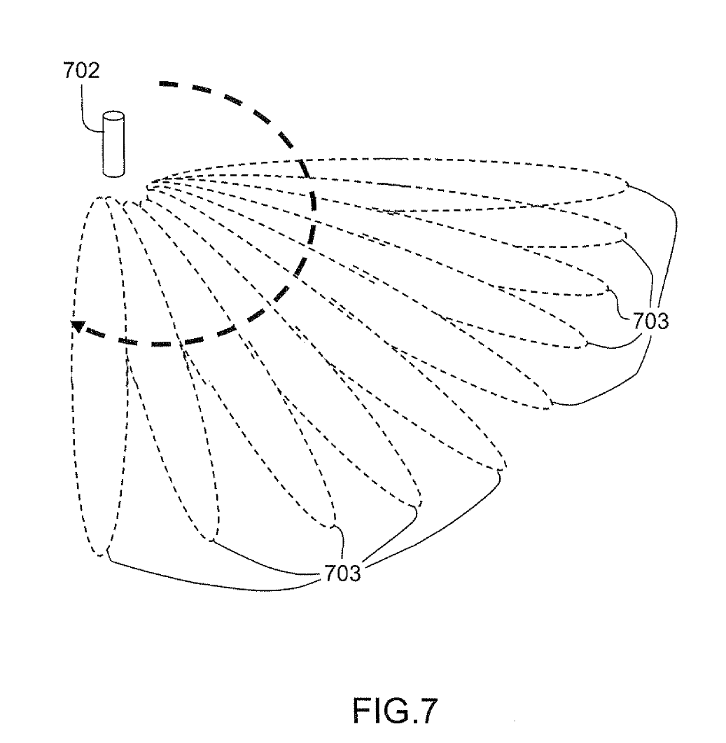

FIG. 7, an exemplary procedure for determining the direction of pointing of the antenna of the antennal device according to the invention.

For the sake of clarity, the same references in different figures designate the same elements.

FIG. 1 a presents the architecture of a first system 100 comprising an antennal device 102 according to the invention. The antennal device 102 comprises a calculation unit 104, a communication interface 105, and an FESA antenna 106. The antennal device 102 is linked to a radioelectric facility, which, in the example, is a modem 108, which comprises a communication interface 110. A cable 112 links the antennal device 102 and the modem 108 so as to transport the radiofrequency signals received or transmitted by the antenna 106. Furthermore, a link 114 linking the communication interface 110 of the modem 108 to the communication interface 105 of the antennal device 102 makes it possible to convey measurement parameters for the modem 108 to the antennal device 102. These measurement parameters characterize the radiofrequency signal received by the modem 108 and allow the antennal device to determine an antenna direction which maximizes communication quality criteria chosen beforehand. By way of example, for an antennal device disposed on a mobile subscriber station linked with a central transmitter, the measurement parameters conveyed to said device allow the latter to execute a procedure which determines which orientation its antenna must have so as to communicate in an optimal manner with the central transmitter. According to another implementation of the device according to the invention, the link 114 is effected via the cable 112, a single physical linkup then being necessary between the modem 108 and the antennal device 102.

In contradistinction to a conventional system, no calculation to determine the direction of pointing of the antenna 106 is performed in the modem 108. This is because the measurement parameters conveyed by the link 114 allow the calculation unit 104 of the antennal device 102 to determine the antenna 106 direction best suited to the use of said antenna 106. The measurement parameters conveyed between the modem 108 and the antennal device 102 are, for example, the binary error rate of a radiofrequency signal received and demodulated or the power of said signal. The direction thus chosen by the calculation unit 104 is conveyed to the antenna 106 via a linkup 107. The modem does not therefore execute specific processings requiring adaptations of its MAC layer. Only modifications of higher level (at least of level 3 according to the OSI model) may be necessary depending on the modem 108 which is associated with the antennal device 102 according to the invention.

Moreover, the elements of the antennal device 102, that is to say the FESA antenna 106, the calculation unit 104 and the communication interface 105, are, preferably, placed in one and the same physical housing so that the antennal device 102 according to the invention takes the form of an independent entity that can easily be hooked up to a radioelectric facility provided with a standard interface, the facility operating in the same frequency band.

FIG. 1b presents the architecture of a second system 100′ comprising an antennal device 102 according to the invention. With respect to the first system 100 presented in FIG. 1, the link 114 linking the communication interface 110 of the modem 108 to the communication interface 105 of the antennal device 102 is replaced with a link using the “Power over Ethernet” technology, designated more simply by the contraction “PoE” subsequently. The modem 108 and the antennal device 102 are each connected to a data bus 151, 151′ supplied with current 162, 162′ by a PoE module 161, 161′. The two PoE modules 161, 161′ are themselves interconnected via a switch 171 hooked up to an Ethernet network 181.

FIG. 2 presents the architecture of a first embodiment of the antennal device according to the invention. The antennal device 202 comprises an FESA antenna 106 and a processing module 204. The antennal device 202 is associated with a modem 208 provided with a communication interface 210, in the example an Ethernet port 210. The radioelectric signals received or transmitted by the antenna 106 are conveyed to the modem 208 via a cable 212.

The processing module 204 of the antennal device 202 comprises a communication port 222 which in the example is an Ethernet port 222. This Ethernet port 222 is, in the example, linked to a supply voltage adaptor 224, which is linked to a calculation unit 226 which, in the example, is a microcontroller 226. The processing module 204 is supplied with current through its Ethernet port 222, by virtue of the “Power over Ethernet” technology.

The measurement parameters are conveyed via a network cable 221 from the Ethernet port 210 of the modem 208 to the Ethernet port 222 of the processing module 204. The voltage adaptor 224 makes it possible to reduce the voltage delivered by the Ethernet port 222 to a voltage compatible with the operation of the microcontroller 226 and of the FESA antenna 106. According to another embodiment of the antennal device according to the invention, the microcontroller 226 and the FESA antenna operate with a voltage identical to that delivered by the Ethernet port 222, thereby dispensing with the use of an adaptor 224. The measurement parameters are thereafter conveyed to the microcontroller 226 via the voltage adaptor 224.

The microcontroller 226 executes processings making it possible to determine the direction of pointing of the antenna 106 most suited to the use which is made of said antenna 106. Several types of processings may be executed for the purposes of determining this direction of pointing. The determination of the direction of pointing of the antenna 106 can for example be performed according to an omnidirectional polling procedure, this procedure being detailed further on with regard to FIG. 7. The procedure for determining the direction of pointing of the antenna may be a piece of software recorded in a memory associated with the microcontroller 226. According to another embodiment, the procedure is executed by a programmable circuit present in the processing module 204.

The direction of pointing determined by the antennal device 202 is conveyed to the antenna 106 via a linkup 227, which can, for example, be a parallel bus or a serial bus. The parallel bus exhibits the advantage of being more effective in terms of latency. Nonetheless, a serial bus makes it possible to minimize the number of conductors of the linkup 227—in this instance, the number of conductors corresponds to the number of wires required for choosing the direction of pointing, for example for 64 possible directions, 6 or more bits are used to code the direction, therefore 6 or more conductors—and also to implement a larger number of radiation patterns, notably those suitable for rejecting undesirable signals present in certain directions.

FIG. 3 presents the architecture of a second embodiment of the antennal device according to the invention. The antennal device 302 comprises an FESA antenna 106 and a processing module 304. The antennal device 302 is associated with a modem 308 provided with a communication interface 310, in the example a serial port 310. The radiofrequency signals received or transmitted by the antenna 106 are conveyed to the modem 308 via a cable 312.

The processing module 304 of the antennal device 302 comprises a serial port 322, a calculation unit 326, and a voltage adaptor 324. With respect to the first embodiment presented in FIG. 2, the processing module 304 is supplied through a dedicated link 330 which hooks up to the voltage adaptor 324 so as to supply the serial port 322 and the microcontroller 326 at compatible voltages.

The measurement parameters are conveyed via a network cable 321 from the serial port 310 of the modem 308 to the serial port 322 of the processing module 304, and then conveyed to the microcontroller 326 which determines a direction of pointing of the antenna 106.

FIG. 4 presents the architecture of a third embodiment of the antennal device according to the invention. The antennal device 402 comprises an FESA antenna 106 and a processing module 404. The antennal device 402 is associated with a modem 408 provided with a multiplexed communication interface 410. The radiofrequency signals received or transmitted by the antennal device 402 are conveyed to the modem 408 via a cable 412, which cable 412 also transports the measurement parameters allowing the antennal device 402 to determine the direction of pointing of the antenna 106. The cable 412 also makes it possible to supply current to the antennal device 402. The communication interface 410 of the modem 408 performs a multiplexing of the radiofrequency signal, of the measurement parameters and of the supply voltage to the antennal device 402.

The processing module 404 comprises a supply voltage adaptor 424, a calculation unit 426 and a communication interface 422 for demultiplexing the radiofrequency signal to be transmitted, the measurement parameters and the supply voltage. According to one embodiment of the device according to the invention, the communication interface 422 is also able to perform a multiplexing of the radiofrequency signal, of the messages sent to the modem 408 such as those of the procedure illustrated further on in FIG. 6. The voltage adaptor 424 makes it possible to supply the calculation unit 426 and the FESA antenna 106 at a compatible voltage.

The result of the multiplexing performed within the modem 408 is conveyed to the cable 412 and received by the demultiplexing communication interface 422 included in the processing module 404. This demultiplexing interface 422 conveys the supply current to the voltage adaptor 424; it also conveys the radiofrequency signal to the FESA antenna 106, and the measurement parameters for the radiofrequency signal to the calculation unit 426, which determines a direction of pointing of the antenna 106.

FIG. 5 presents the architecture of a fourth embodiment of the antennal device according to the invention. The antennal device 502 comprises an FESA antenna 106 and a processing module 504. The antennal device 502 is associated with a modem 508 provided with a communication interface 510, in the example a short-range radio transmission/reception port 510. The modem 508 also comprises a second multiplexing interface 511 conveying to a cable 512 the supply current of the antennal device 502 and the radiofrequency signals received or transmitted by the antenna 106.

The processing module 504 of the antennal device 502 comprises a short-range radio transmission/reception port 523, a calculation unit 526, a voltage adaptor 524 and a demultiplexing interface 522 suitable for receiving the radiofrequency signals and the supply current conveyed through the cable 512. The demultiplexing interface 522 conveys the supply current to the voltage adaptor 524 and the radiofrequency signals to the antenna 106.

The measurement parameters are conveyed via a wireless link 521 of the radio transmission/reception port 510 of the modem 508 to the radio transmission/reception port 523 of the processing module 504, and then conveyed to the calculation unit 526 which determines a direction of pointing of the antenna 106.

FIG. 6 presents an exemplary protocol for exchange between a radioelectric facility 608 and an antennal device 602 according to the invention. Several modes may be employed to initialize the communication between the radioelectric facility 608 and the antennal device 602.

According to a first mode of operation, the radioelectric facility 608 transmits a message INIT-REQ to the antennal device 602 so as to initiate the communication. A response INIT-RSP from the antennal device 602 to the radioelectric facility 608 is necessary so that the communication is established. In the absence of a response originating from the antennal device 602, the radioelectric facility 608 re-transmits a message INIT-REQ to the antennal device 602 after a fixed duration.

The calculation unit of the antennal device 602 prepares to start its search action for the best radiation pattern upon reception of the message INIT_REQ, while the radioelectric facility 608 is informed that this phase of determining the best radiation pattern can commence upon reception of the message INIT_RSP. The message INIT_REQ can contain parameters intended for the antennal device 602. These parameters can for example comprise an identifier of a procedure to be executed by the calculation unit of the antennal device 602 so as to determine the direction of pointing of the antenna.

Thereafter, to start the execution of the procedure for determining the direction of pointing of the antenna, the radioelectric facility 608 conveys a BEAM-SCAN-ORDER message for which the antennal device 602 acknowledges receipt through a BEAM-SCAN-ORDER-ACK response message.

The antennal device 602 then begins the search procedure for the best direction of pointing of the antenna, stated otherwise the radiation pattern which maximizes the quality criteria chosen by the user of the antenna. During this procedure, several radiation patterns are successively tested. By way of example, if it is desired to obtain a radiation pattern making it possible to obtain the best signal-to-noise ratio on reception of the radiofrequency signal, the procedure will test several radiation patterns until the one leading to the best signal-to-noise ratio is obtained.

Signal measurements are requested by the sending of a request MEAS-REQ from the antennal device 602 to the radioelectric facility 608 for each radiation pattern tested. The radioelectric facility 608 responds to this request MEAS-REQ by sending a message MEAS-RSP to the antennal device 602, which message comprises the measurement parameters useful to the calculation unit of the antennal device 602. These measurement parameters can, for example, comprise the value of the signal-to-noise ratio of the radiofrequency signal received, the binary error rate obtained after demodulation or else a power indicator for the signal received, commonly designated by the expression “Received Signal Strength Indication” or RSSI.

Finally, the antennal device 602 informs the radioelectric facility 608 of the end of the execution of the search procedure for the best direction of pointing of the antenna by conveying a BEAM-SCAN-RSP message, to which message the radioelectric facility 608 responds with an acknowledgment message BEAM-SCAN-RSP-ACK.

On completion of the procedure, the calculation unit of the antennal device 602 has determined the best radiation pattern and can therefore command the antenna so as to obtain said pattern.

The protocol described previously generally requires adaptations of the radioelectric facility 608—adaptations nonetheless performed at a higher level than the MAC access layer—because it is necessary that the radioelectric facility 608 be able to process the messages conveyed by the antennal device 602 and that it can, in turn, transmit a message comprehensible by the antennal device 602.

In the case where no modification is tolerated in the radioelectric facility 608, another mode of initialization of the communication is employed.

According to this second mode of initialization, when the antennal device 602 is powered up, it places itself on standby awaiting the measurement parameters conveyed by the radioelectric facility 608. The reception of the first parameter triggers the procedure for determining the best direction of pointing of the antenna. When this direction is determined, it is maintained until the reception by the antennal device 602 of parameters indicating a degradation of the quality of the signal below a fixed threshold. When said threshold is crossed, a new procedure for determining the direction of pointing is executed. For example, the reception of a measurement parameter containing an RSSI value which is below a predetermined threshold can trigger a new execution of said procedure.

FIG. 7 presents an exemplary procedure for determining the best direction of pointing of the antenna of the antennal device 702 according to the invention. The procedure presented in FIG. 7 is an omnidirectional polling procedure. All the possible directions of the main radiation lobe 703 of the FESA antenna are successively scanned. On completion of this scan, the radiation pattern adopted is the one whose measurements make it possible to maximize the chosen signal quality criteria. The execution time for this procedure depends mainly on the number of radiation patterns available on the FESA antenna and the time taken by the radioelectric facility to analyze the signal. Other procedures for determining the direction of pointing, which are not detailed in this document, may be executed by the calculation unit of the device according to the invention.

An advantage of the antennal device according to the invention is that it may be easily adapted to the cases of use and of the topology of the network without having to perform any unwieldy intervention on the radioelectric facility with which it is linked. Thus, a change of procedure for determining the direction of pointing of the FESA antenna present in a device according to the invention requires a simple updating of the software and/or of the programmable circuits present on the antenna, without impacting on the radioelectric facility.

1. An antennal device comprising an electron beam switching antenna, said device being linkable by a cable to a radioelectric facility, said device further comprising a calculation unit able to determine and command a direction of pointing of the beam of the antenna on the basis of measurement parameters for the radiofrequency signal conveyed from said device to said facility and processed by said facility, said parameters being conveyed by said facility on a communication interface of said device.

2. The antennal device as claimed in claim 1, wherein the measurement parameters for the radiofrequency signal comprise at least one value from among the following:
a power indicator for said signal; and
an indicator of quality of the communication linkup effected via said signal.

3. The antennal device as claimed in claim 1, the radioelectric facility being provided with an Ethernet port wherein the communication interface, suitable for receiving the measurement parameters, is an Ethernet port to supply voltage to the calculation unit and the antenna.

4. The antennal device as claimed in claim 3, wherein a supply voltage adaptor to reduce the supply voltage to a voltage compatible with the operation of the calculation unit and the antenna is placed between the Ethernet port and the calculation unit.

5. The antennal device as claimed in claim 1, wherein the radioelectric facility is provided with a serial port, and the communication interface, suitable for receiving the measurement parameters, is a serial port, the device further comprising a specific access for the electrical power supply.

6. The antennal device as claimed in claim 1, wherein the radioelectric facility is provided with a multiplexing interface and the communication interface, suitable for receiving the measurement parameters, is able to receive and to demultiplex an electrical supply current, messages arising from the radioelectric facility and the radiofrequency signal to be transmitted by the antenna, said messages comprising said measurement parameters.

7. The antennal device as claimed in claim 1, wherein the radioelectric facility is provided with a multiplexing interface and with a first short-range radio transmission/reception port and the communication interface, suitable for receiving the measurement parameters, is a second short-range radio transmission/reception port, messages arising from the radioelectric facility being conveyed on a wireless link between the first radio transmission/reception port and the second radio/transmission port, said messages comprising said measurement parameters.

8. The antennal device as claimed in claim 6, wherein the messages conveyed between the radioelectric facility and the antennal device comprise orders for controlling the calculation unit.

9. An antennal system comprising a modem configured to control an electron beam switching antenna, wherein the antenna is included in an antennal device as claimed in claim 1.
